(19) United States
(12) Patent Application Publication
(10) Pub. No.: US 2025/0286109 A1
(43) Pub. Date: Sep. 11, 2025

(54) METHOD FOR CONSOLIDATING MULTILAYER FOILS USING HOT PRESSING

(71) Applicant: GM Global Technology Operations LLC, Detroit, MI (US)

(72) Inventors: Junjie Ma, Novi, MI (US); Masoud MohammadPour, Novi, MI (US); Teresa J. Rinker, Royal Oak, MI (US); Hui-ping Wang, Troy, MI (US); Blair E. Carlson, Ann Arbor, MI (US); Vincent Edward Herrman, Clawson, MI (US); Subrahmanyam Goriparti, Troy, MI (US); Changshuai Dou, Shanghai (CN)

(21) Appl. No.: 18/609,594

(22) Filed: Mar. 19, 2024

(30) Foreign Application Priority Data
Mar. 8, 2024 (CN) 2024102684339

(51) Int. Cl. H01M 10/04; H01M 50/536; H01M 50/54

(52) U.S. Cl. CPC H01M 10/0468; H01M 50/536; H01M 50/54

(57) ABSTRACT

A method for consolidating a foil tab stack is provided. The method includes combining foil tabs of an electrode stack in a battery cell to form a combined foil tab stack. Additionally, the method includes hot-pressing the combined foil tab stack using heated pressing dies to form a consolidated foil tab stack. Further, the method includes laser welding the consolidated foil tab stack to a terminal lead using a laser welder.

### INTRODUCTION

The present disclosure relates to electrode stacks in a battery cell and more particularly to consolidating electrode tabs within the electrode stacks.

A battery cell, for example a prismatic battery cell, typically includes a plurality of electrode stacks. Each of the electrode stacks includes anode electrode tabs and cathode electrode tabs extending from the electrode stack. The electrode tabs of the electrode stacks are welded and connected to terminal leads or current collectors. The current collectors are metal plates that consolidate and transmit the electric current generated by the electrode stacks to the terminals on the battery cell. When welding the electrode tabs, surface contamination on the electrode tabs may cause gases to be released, which may form air cavities. These air cavities combined with tension caused by shrinkage during solidification may lead to detachment of electrode tabs at fusion boundaries.

While prior art methods and systems attempt to minimize detachment of electrode tabs at fusion boundaries and may achieve their particular purpose, a need still exists for a new and improved method for reducing detachment of the electrode tabs. Accordingly, a method that minimizes detachment of the electrode tabs is needed.

### SUMMARY

According to several aspects of the present disclosure, a method for consolidating a foil tab stack is provided. The method includes combining foil tabs of an electrode stack in a battery cell to form a combined foil tab stack. Additionally, the method includes hot-pressing the combined foil tab stack using heated pressing dies to form a consolidated foil tab stack. Further, the method includes laser welding the consolidated foil tab stack to a terminal lead using a laser welder.

In accordance with another aspect of the disclosure, the method includes hot-pressing foil tabs formed from at least one of copper or aluminum.

In accordance with another aspect of the disclosure, the method includes heating the combined foil tab stack to a temperature between 350 Kelvin and 680 Kelvin and holding the temperature for between 5 seconds and 30 minutes.

In accordance with another aspect of the disclosure, the method includes using an induction-heated pressing die when hot-pressing the combined foil tab stack.

In accordance with another aspect of the disclosure, the method includes using a resistive-heated pressing die when hot-pressing the combined foil tab stack.

In accordance with another aspect of the disclosure, the method includes forming at least one indentation feature in the combined foil tab stack with the heated pressing dies when hot-pressing the combined foil tab stack.

In accordance with another aspect of the disclosure, the method includes forming at least one wave feature in the combined foil tab stack with the heated pressing dies when hot-pressing the combined foil tab stack.

In accordance with another aspect of the disclosure, the method includes forming at least one rib feature in the combined foil tab stack with the heated pressing dies when hot-pressing the combined foil tab stack.

In accordance with another aspect of the disclosure, the method includes using a high frequency oscillating laser when laser welding the combined foil tab stack.

In accordance with another aspect of the disclosure, the method further includes cooling at least one of a portion of a clamp or a subclamp configured to hold the electrode stack during hot-pressing the combined foil tab stack.

In accordance with another aspect of the disclosure, the method includes using a Peltier plate when cooling at least the portion of the clamp.

In accordance with another aspect of the disclosure, the method includes using cooling channels in the subclamp when cooling at least the portion of the clamp.

According to several aspects of the present disclosure, a method for consolidating a foil tab stack is provided. The method includes combining foil tabs of an electrode stack in a battery cell to form a combined foil tab stack. The method includes clamping the combined foil tab stack to hold the combined foil tab stack in place. The electrode stack is supported by a clamp, and the combined foil tab stack is supported by a subclamp. The method includes hot-pressing the combined foil tab stack using heated pressing dies to form a consolidated foil tab stack. Moreover, the method includes laser welding the consolidated foil tab stack to a terminal lead using a laser welder.

In accordance with another aspect of the disclosure, the method includes heating the combined foil tab stack to a temperature between 350 Kelvin and 680 Kelvin and holding the temperature for between 5 seconds and 30 minutes when hot-pressing the combined foil tab stack.

In accordance with another aspect of the disclosure, the method includes using a pressing die that incorporates induction coils into a clamp that presses the combined foil tab stack when hot-pressing the combined foil tab stack. The induction coils heat the combined foil tab stack.

In accordance with another aspect of the disclosure, the method further includes cooling at least one of a portion of the clamp or the subclamp configured to hold the electrode stack during hot-pressing the combined foil tab stack.

According to several aspects of the present disclosure, a method for consolidating a foil tab stack is provided. The method includes combining foil tabs of an electrode stack in a battery cell to form a combined foil tab stack. The foil tabs are formed of copper or aluminum. The method includes clamping the combined foil tab stack to hold the foil tab stack in place. The electrode stack is supported by a clamp, and the combined foil tab stack is supported by a subclamp. The method includes hot-pressing the combined foil tab stack using heated pressing dies to form a consolidated foil tab stack. The method includes cooling at least a portion of the consolidated foil tab stack using a cooling system, where the cooling system is integrated into the subclamp. The method includes laser welding the consolidated foil tab stack to a terminal lead using a high frequency oscillating laser welder.

In accordance with another aspect of the disclosure, the method includes using a Peltier plate when cooling at least the portion of the clamp.

In accordance with another aspect of the disclosure, the method includes heating the combined foil tab stack to a temperature between 350 Kelvin and 680 Kelvin and holding the temperature for between 5 seconds and 30 minutes when hot-pressing the combined foil tab stack.

In accordance with another aspect of the disclosure, the method includes using cooling channels in the subclamp when cooling at least the portion of the clamp.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle including a battery pack having a plurality of battery cells, in accordance with the present disclosure.

FIG. 2A is a perspective view illustrating a battery cell disposed within the battery pack shown in FIG. 1, where the battery cell includes at least one electrode stack having a plurality of electrode tabs welded to a current collector, in accordance with the present disclosure.

FIG. 2B is a partial cross-sectional view through the battery cell, as indicated in FIG. 2A, illustrating the layers in a single electrode stack and a set of anode electrode tabs and a set of cathode electrode tabs, in accordance with the present disclosure.

FIG. 3 is a flowchart illustrating a method for laser welding the anode and cathode electrode tabs to the current collectors using hot-pressing, in accordance with the present disclosure.

FIG. 4 is a perspective view illustrating an electrode stack and a combined foil tab stack shown in FIG. 2A, where a clamp and subclamp is supporting the electrode stack and combined foil tab stack, in accordance with the present disclosure.

FIG. 5 is a perspective view illustrating an electrode stack and a combined foil tab stack shown in FIG. 4, where a pressing die is hot-pressing the combined foil tab stack, in accordance with the present disclosure.

FIG. 6 is a perspective view illustrating the electrode stack and a consolidated foil tab stack resulting from hot-pressing the combined foil tab stack shown in FIG. 4, in accordance with the present disclosure.

FIG. 7 is an isometric perspective view illustrating the electrode stack and the consolidated foil tab stack shown in FIG. 4, in accordance with the present disclosure.

FIG. 8 is a perspective view illustrating a combined foil tab stack and pressing dies for hot-pressing the combined foil tab stack, in accordance with the present disclosure.

FIG. 9 is a perspective view illustrating a consolidated foil tab stack subsequent to hot-pressing the combined foil tab stack shown in FIG. 8, in accordance with the present disclosure.

FIG. 10 is a perspective view illustrating a combined foil tab stack and pressing dies for hot-pressing the combined foil tab stack, where the pressing dies are configured to create a feature in the resulting consolidated foil tab stack, in accordance with the present disclosure.

FIG. 11 is a perspective view illustrating a consolidated foil tab stack resulting from hot-pressing the combined foil tab stack shown in FIG. 10, where the features created in the consolidated foil tab stack include indentation features, in accordance with the present disclosure.

FIG. 12 is a perspective view illustrating a consolidated foil tab stack resulting from hot-pressing the combined foil tab stack shown in FIG. 10, where the features created in the consolidated foil tab stack include a wave feature, in accordance with the present disclosure.

FIG. 13 is a perspective view illustrating a consolidated foil tab stack resulting from hot-pressing the combined foil tab stack shown in FIG. 10, where the features created in the consolidated foil tab stack include rib features, in accordance with the present disclosure.

FIG. 14 is a perspective view illustrating a combined foil tab stack supported by a clamp and subclamp with a trimming feature for trimming an end of the combined foil tab stack, in accordance with the present disclosure.

FIG. 15 is a perspective view illustrating a consolidated foil tab stack trimmed with the trimming feature shown in FIG. 14, in accordance with the present disclosure.

FIG. 16 is a perspective view illustrating an electrode stack and combined foil tab stack supported by a clamp and a subclamp, where the clamp and the subclamp include a cooling system having cooling channels supplied by a coolant, in accordance with the present disclosure.

FIG. 17 is a perspective view illustrating an electrode stack and combined foil tab stack supported by a clamp and a subclamp, where the clamp and the subclamp include a cooling system having a Peltier plate, in accordance with the present disclosure.

FIG. 18 is a perspective view illustrating a consolidated foil tab stack welded to a terminal lead, where the resulting weld is a butt joint weld, in accordance with the present disclosure.

FIG. 19 is a perspective view illustrating a consolidated foil tab stack welded to a terminal lead, where the resulting weld is a lap joint weld with the weld location a distance from an end of the consolidated foil tab stack, in accordance with the present disclosure.

FIG. 20 is a perspective view illustrating a consolidated foil tab stack welded to a terminal lead, where the resulting weld is a lap joint weld with the weld location at end of the consolidated foil tab stack, in accordance with the present disclosure

FIG. 21 is a perspective view illustrating two consolidated foil tab stacks each supported by a clamp and a subclamp having Peltier plates, where one Peltier plate is heating the first consolidated foil tab stack and a second Peltier plate is cooling the second consolidated foil tab stack during a welding process, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

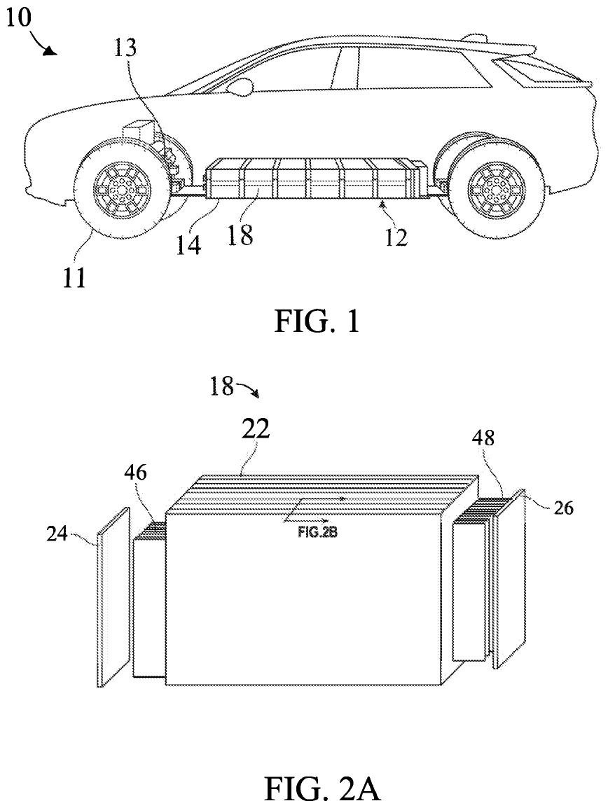

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 11 driven by electric motors/inverters 13. The electric motors/inverters 13 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 14 for supporting a plurality of battery cells 18. The battery pack 12 may have fifty or more battery cells 18.

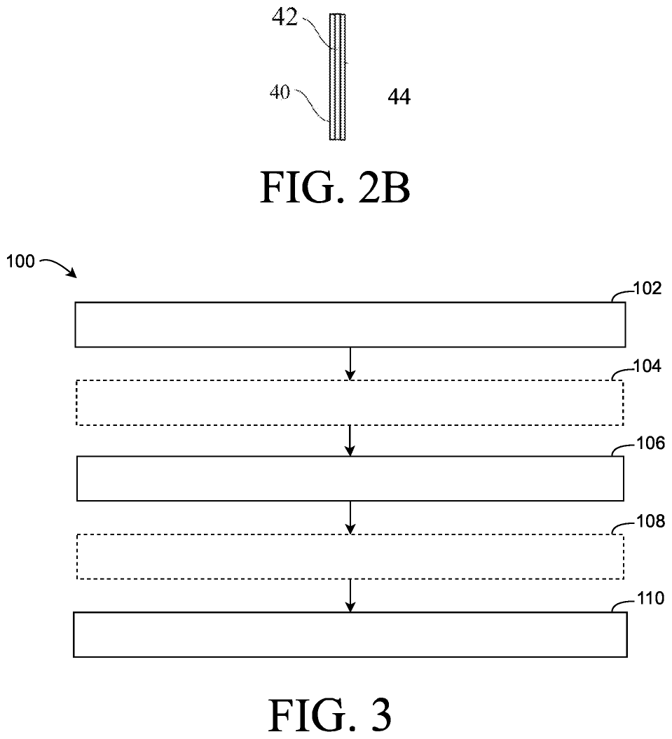

Referring now to FIG. 2A, a perspective view of a battery cell 18 disposed within the battery pack 12 shown in FIG. 1 is illustrated, in accordance with an aspect of the present disclosure. Each battery cell 18 has a housing or case (not shown) and a plurality of electrode stacks 22. Each battery cell 18 may have hundreds of electrode stacks 22. Each electrode stack 22 is connected to a current collector 24, 26. Moreover, electrode stacks 22 are placed in the housing and the housing is filled with a suitable electrolyte. For example, the electrolyte is a liquid solution of organic solvents and lithium salts. Current collectors 24, 26 are thin metal plates or foils disposed on either side of the electrode stacks 22 typically having a thickness of between 0.4 and 1 millimeter. The current collectors may be made of copper or aluminum, for example. The current collectors 24, 26 are attached to the electrode stacks 22 to transmit the electric current to an external circuit.

With additional reference to FIG. 2B, a partial cross-sectional view through the battery cell 18, as indicated in FIG. 2A, illustrates the layers in a single electrode stack 22, in accordance with the present disclosure. Each electrode stack 22 is comprised of a negative electrode or anode electrode 40 (a foil tab) extending from a first side of the electrode stack 22, a separator 42, and positive electrode or cathode electrode 44 (a foil tab) extending from a second side of the electrode stack 22. The anode electrode 40 is generally a thin metal plate or foil that includes an anode electrode tab 46 (shown in FIG. 2A) for providing an electrical connection between the anode electrode and current collector 24. Similarly, cathode electrode 44 is a thin metal plate or foil that includes a cathode electrode tab 48 (shown in FIG. 2A) for providing an electrical connection between the cathode electrode 44 and current collector 26. Multiple cathode electrode tabs form a foil tab stack.

The anode electrode 40 and the anode electrode tab 46 are made, for example, of copper or other suitable material and typically coated with graphite or graphite/silicon or other carbon-based materials or silicon oxide or lithiated silicon. The cathode electrode 44 and cathode electrode tab 48 are made, for example, of aluminum or other suitable material and typically coated with a metal oxide, such as Lithium cobalt oxide (LCO) or nickel-cobalt-aluminum (NCA) or lithium iron/manganese phosphate (LFP/LFMP) or Lithium manganese rich (LMR). The different metals (copper anode and aluminum cathode) of battery cell 18 produce a galvanic reaction in battery cell 18. The copper, for example, of anode electrode 40, and the aluminum, for example, of cathode electrode 44, have different standard reduction potentials and are separated by one another by the separator 42. The aluminum having the lower potential will oxidize and release electrons, while the copper having a higher potential will reduce and accept electrons. This process of releasing and accepting electrons generates an electric current that may be used to power devices. Multiple anode electrode tabs form a foil tab stack.

The separator 42 is generally a thin a porous membrane or layer of material that is positioned between the anode electrode 40 and the cathode electrode 44 and prevents the anode electrode 40 and cathode electrode 44 from touching and causing a short circuit. The separator 42 allows the lithium ions to pass through and complete the circuit. A composite material that is porous and chemically stable such as composites made with polyethylene (PE), polypropylene (PP) or other natural materials of the like may be used as the separator 42. Moreover, inorganic nanoparticles such as TiO2, SiO2, Al2O3 and ZrO2 may also be used to create coating composites for separator 42. Separator 42 increases the internal resistance of battery cell 18 that reduces power output and efficiency of the battery. The internal resistance depends on the thickness porosity and composition of the separator 42. The separator 42 is also selected to withstand high temperatures and manage thermal runaway preventing an uncontrollable rise in temperature due to exothermic reactions. Moreover, the separator 42 has a high melting point and a low shrinkage rate to avoid contact between the anode electrode 40 and cathode electrode 44. The separator 42 has sufficient mechanical strength to resist puncture, tear, or deformation during fabrication and operation of cell assembly. The separator 42 also is dimensionally stabile and flexible to conform to the shape of the electrodes and accommodate volume changes during cycling. The separator 42 is chemically inert and compatible with the electrolyte, electrodes and other cell components. Additionally, separator 42 has a low affinity for water or other impurities that can contaminate the electrolyte or cause corrosion of the electrodes.

With reference to FIG. 3, a method 100 for consolidating a foil tab stack of the electrode stack 22 within the battery cell 18 is presented, in accordance with the present disclosure.

The method starts at block 102. Block 102 depicts combining foil tabs 46, 48 of the electrode stack 22 in the battery cell 18 to form a combined foil tab stack 52. Combining the foil tabs 46, 48 may include pre-assembling the electrode stack 22 in an upstream stacking process. For example, the anode electrodes 40, the cathode electrodes 44, and the separators may be deposited in a magazine (not shown) in a stacking wheel (not shown) and respectively arranged to form the electrode stack 22. In this arrangement, the anode electrode tabs 46 extend from a first side of the electrode stack 22 and form a combined foil tab stack 52 comprising the anode electrode tabs 46. The cathode electrode tabs 48 extend from another side of the first side of the electrode stack 22 or another portion of the first side of the electrode stack 22 (i.e. distant from the anode electrode tabs 46 and form a combined foil tab stack 52 comprising the cathode electrode tabs 48. The combined foil tab stack 52 may include either anode electrode tabs 46 or cathode electrode tabs 48. In one example, the combined foil tab stack 52 includes a stack of 50 electrode tabs, although the number of electrode tabs may vary (e.g., less than 25 electrode tabs to more than 100 electrode tabs. The method then may move to block 104.

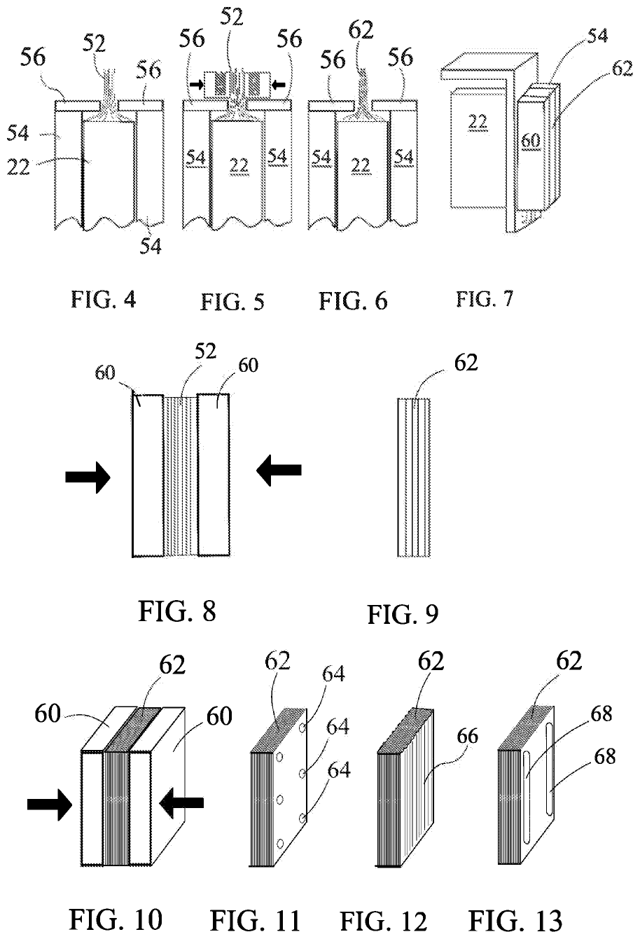

Block 104 depicts clamping the combined foil tab stack 52 in place using a clamp 54 or a subclamp 56. Clamping the combined foil tab stack 52 may include using only a clamp 54 or both a clamp 54 and subclamp 56. As used herein and shown in FIG. 4, the clamp 54 is used to hold and support the electrode stack 22, and the subclamp 56 is used to hold and support the combined foil tab stack 52 in preparation for hot-pressing, although it should be appreciated that other configurations for the clamp 54 and the subclamp 56 may be used. Clamping can provide a joining force for additional combination of the combined foil tab stack 52. Homogenous clamping of the combined foil tab stack 52 is beneficial due to low inherent stiffness of the electrode tabs in the combined foil tab stack 52 and residual stresses induced by rolling and winding processes during production and combination of the anode electrode tabs 46 and the cathode electrode tabs 48. When the subclamp 56 is used, the subclamp 56 may contact only a portion of the combined foil tab stack 52 (e.g., a portion not intended for hot-pressing). In some instances, clamping the combined foil tab stack 52 may occur during a preassembly step and/or during an upstream stacking process. Additionally, the clamp 54 and/or the subclamp 56 may be integrated with a pressing die 60. Further, the clamp 54 and/or the subclamp 56 may be heated using, for example, inductive heating (e.g., an induction-heated clamp and/or induction-heated subclamp) and/or resistive heating (e.g., a resistive-heated clamp and/or resistive-heated subclamp). A pressing die 60, which incorporates induction coils into a non-conductive tooling, can press the combined foil tab stack 52, and the induction coils heat the foils to engage diffusion bonding. The method then moves to block 106.

Block 106 depicts hot-pressing the combined foil tab stack 52 using heated pressing dies 60 to form a consolidated foil tab stack 62. Hot-pressing the combined foil tab stack 52 heats the combined foil tab stack 52 and presses the individual electrode tabs together. The hot-pressing step vaporizes surface contamination and moisture on the individual electrode tabs while minimizing air cavities within the consolidated foil tab stack 62. Hot-pressing reduces porosity and detachment within the consolidated foil tab stack 62 in subsequent welding steps.

FIGS. 5, 8, 10, 14-16, and 21 illustrate a set of heated pressing dies 60 hot-pressing the combined foil tab stack 52 resulting in the consolidated foil tab stack 62, such as the consolidated foil tab stack 62 illustrated in FIGS. 6 and 9. The pressing dies 60 may include resistive-heated pressing dies 60, induction-heated pressing dies 60, and the like. In one specific example, a combined foil tab stack 52 including 50 tabs with an initial total thickness of 890 microns (μm) before a hot-pressing step is hot pressed resulting in a consolidated foil tab stack 62 having a resulting total thickness of about 812 μm. In this example, the difference in thickness is due to the hot-pressing step and elimination of surface contamination and air cavities that initially exist between the foil tabs 46, 48. In another example, hot-pressing the combined foil tab stack 52 may include heating the combined foil tab stack 52 to a temperature between 350 Kelvin (K) and 680 K and holding the temperature for between ten seconds and thirty minutes. It should be appreciated that a variety of temperatures and holding times may be used for hot-pressing. For example, the hot-pressing temperature may be from 300K or less to 900K or greater as long as a melting temperature of the combined foil tab stack 52 is not reached. The hot-pressing time may be from 5 seconds or less to 30 minutes or more.

Referring to FIGS. 10 through 13, hot-pressing the combined foil tab stack 52 may include forming at least one feature in the combined foil tab stack 52. FIG. 10 illustrates hot-pressing the combined foil tab stack 52 with heated pressing dies having features configured to impress and/or form the features. Referring to FIG. 11, a consolidated foil tab stack 62 is shown having multiple indentation features 64 formed therein. The indentation features 64 may extend into and/or from the resulting consolidated foil tab stack 62. The consolidated foil tab stack 62 may have one or more indentation features 64. FIG. 12 illustrates a consolidated foil tab stack 62 having a wave feature 66 formed therein. The wave feature 66 may be formed on an outside surface and/or throughout the consolidated foil tab stack 62. The wave feature 66 may facilitate improved gas ventilation during a subsequent welding process step. FIG. 13 illustrates a consolidated foil tab stack 62 having multiple rib features 68 formed therein. The rib features 68 may extend into and/or from the consolidated foil tab stack 62. The consolidated foil tab stack 62 may have one or more rib features 68. These features may serve to enhance foil tab consolidation, especially during transfer of the electrode stack 22 to subsequent process locations.

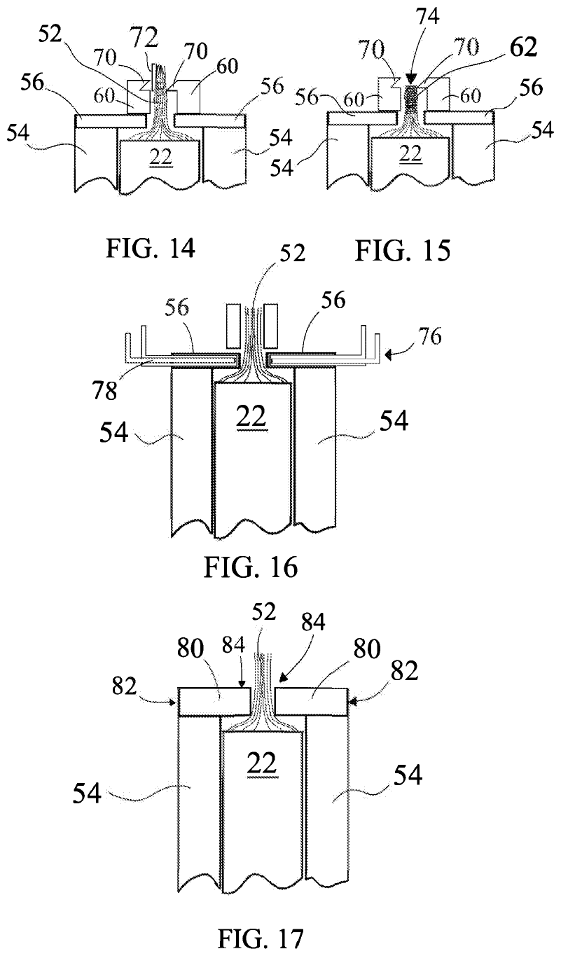

Additionally, hot-pressing the combined foil tab stack 52 may include trimming the combined foil tab stack 52 to allow a consistent clamping fit up. As shown in FIG. 14, the heated pressing die 60 may include a trimming feature 70 that trims and removes a portion 72 of the combined foil tab stack 52 so that an end 74 of the resulting consolidated foil tab stack 62, as shown in FIG. 15, is even and has a consistent fit. The method 100 then may move to block 108.

Block 108 depicts cooling at least a portion of the subclamp 56 using a cooling system 76. For example and referring to FIG. 16, a subclamp 56 having cooling channels 78 may be used for the hot-pressing step depicted in block 106. The cooling channels 78 are embedded and integral with the subclamp 56 and carry a coolant throughout at least a portion of the subclamp 56. While the heated pressing dies 60 heat and press the combined foil tab stack 52, the subclamp 56 cools a portion of the combined foil tab stack 52 and/or electrode stack 22 to avoid overheating the combined foil tab stack 52.

In another example, and referring to FIG. 17, cooling at least a portion of the subclamp 56 may include using a subclamp 56 including a Peltier plate 80. A Peltier plate operates using the Peltier effect, which occurs when an electric current flows through a junction of two different materials. As a result, heat is transferred from one side of the plate (e.g., a cool side 82) to another side of the plate (e.g., a hot side 84). Depending on the direction of the current, the Peltier plate can either absorb heat (becoming cooler) or dissipate heat (becoming hotter). The Peltier plate 80 can be disposed integrally with the subclamp 56 or may be separate from the subclamp 56 and/or clamp 54. The Peltier plate 80 can be arranged so that the hot side abuts and is proximate to the combined foil tab stack 52 and the cold side is away from and distal from the combined foil tab stack 52. The method then moves to block 110.

Block 110 depicts laser welding the consolidated foil tab stack 62 to a terminal lead 86 (e.g., a current collector) using a laser welder 88. The laser welder 88 may include a high frequency oscillating laser welder. It will be appreciated that the laser welder 88 may include a variety of appropriate welders. In an example, laser welding the consolidated foil tab stack 62 may include using the laser welder 88 to high-beam oscillation weld the consolidated foil tab stack 62 to the terminal lead 86 with a vertical 8-shape oscillation pattern subsequent to a hot-pressing step.

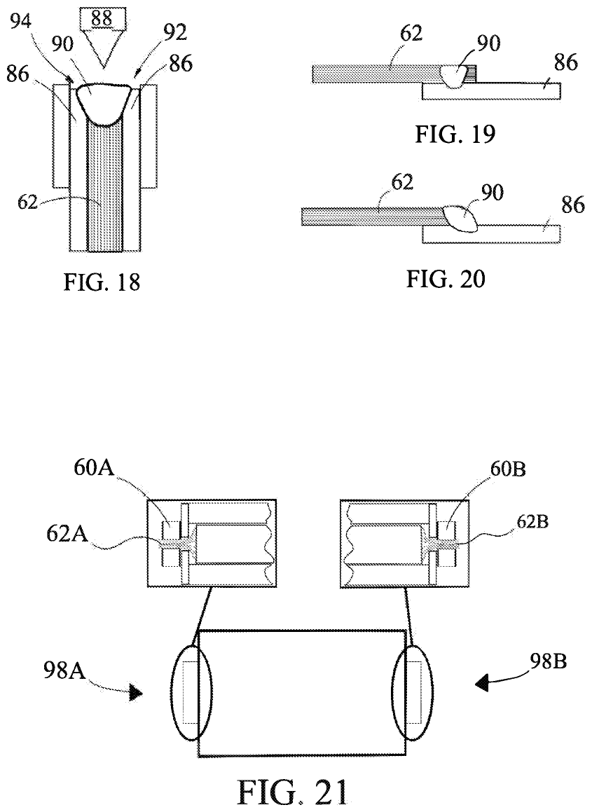

Additionally, the consolidated foil tab stack 62 may be welded to the terminal lead 86 in a variety of configurations. For example, and as depicted in FIG. 18, the consolidated foil tab stack 62 may be welded using the laser welder 88 to the terminal lead 86 in a butt joint configuration, where a resulting weld 90 is disposed at an end 92 of the consolidated foil tab stack 62 and the terminal lead 86.

In the example depicted in FIG. 19, the consolidated foil tab stack 62 is welded in a lap joint configuration, where the resulting weld 90 is disposed on a portion of the consolidated foil tab stack 62 with the consolidated foil tab stack 62 overlapping a portion of the terminal lead 86.

In the example depicted in FIG. 20, the consolidated foil tab stack 62 is welded in a lap joint configuration, where the resulting weld 90 is a fillet weld disposed on a portion of the consolidated foil tab stack 62 with the consolidated foil tab stack 62 overlapping a portion of the terminal lead 86.

Referring to FIG. 21, a heated pressing die 60A may be used to heat a first consolidated foil tab stack 62A located on a first side 98A of the electrode stack 22. A cooled pressing die 60B may be used to cool a second consolidated foil tab stack 62B located on a second side 98B of the electrode stack 22. This heating of the first consolidated foil tab stack 62A and cooling of the second consolidated foil tab stack 62B may be done simultaneously (e.g., during the welding step depicted in block 110) or may be performed at separate times.

The present disclosure is advantageous and beneficial over prior art laser welding of electrode stack tabs. For example, hot-pressing the combined foil tab stack 52 serves to heat up the foil tabs 46, 48 and vaporize surface contamination, often in the form of aluminum oxides, and eliminate air cavities. During subsequent welding steps, gases trapped in the resulting welds due to the rapid solidification rate of aluminum alloys cause formation of pores. The pores, together with tension caused by solidification shrinkage, lead to detachment of foils at fusion boundaries. Using hot-pressing reduces porosity and detachment during subsequent welding.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for consolidating a foil tab stack, comprising:
combining foil tabs of an electrode stack in a battery cell to form a combined foil tab stack;
hot-pressing the combined foil tab stack using heated pressing dies to form a consolidated foil tab stack; and
laser welding the consolidated foil tab stack to a terminal lead using a laser welder.

2. The method of claim 1, wherein the foil tabs are formed from at least one of copper or aluminum.

3. The method of claim 1, wherein hot-pressing the combined foil tab stack includes heating the combined foil tab stack to a temperature between 350 Kelvin and 680 Kelvin and holding the temperature for between 5 seconds and 30 minutes.

4. The method of claim 1, wherein hot-pressing the combined foil tab stack includes using an induction-heated pressing die.

5. The method of claim 1, wherein hot-pressing the combined foil tab stack includes using a resistive-heated pressing die.

6. The method of claim 1, wherein hot-pressing the combined foil tab stack includes forming at least one indentation feature in the combined foil tab stack with the heated pressing dies.

7. The method of claim 1, wherein hot-pressing the combined foil tab stack includes forming at least one wave feature in the combined foil tab stack with the heated pressing dies.

8. The method of claim 1, wherein hot-pressing the combined foil tab stack includes forming at least one rib feature in the combined foil tab stack with the heated pressing dies.

9. The method of claim 1, wherein laser welding the combined foil tab stack includes using a high frequency oscillating laser.

10. The method of claim 1, further comprising:
cooling at least one of a portion of a clamp or a subclamp configured to hold the electrode stack during hot-pressing the combined foil tab stack.

11. The method of claim 10, wherein cooling at least the portion of the clamp includes using a Peltier plate.

12. The method of claim 10, wherein cooling at least the portion of the clamp includes using cooling channels in the subclamp.

13. A method for consolidating a foil tab stack, comprising:
combining foil tabs of an electrode stack in a battery cell to form a combined foil tab stack;
clamping the combined foil tab stack to hold the combined foil tab stack in place, wherein the electrode stack is supported by a clamp, and wherein the combined foil tab stack is supported by a subclamp;
hot-pressing the combined foil tab stack using heated pressing dies to form a consolidated foil tab stack; and
laser welding the consolidated foil tab stack to a terminal lead using a laser welder.

14. The method of claim 13, wherein hot-pressing the combined foil tab stack includes heating the combined foil tab stack to a temperature between 350 Kelvin and 680 Kelvin and holding the temperature for between 5 seconds and 30 minutes.

15. The method of claim 13, wherein hot-pressing the combined foil tab stack includes using a pressing die that incorporates induction coils into a clamp that presses the combined foil tab stack, wherein the induction coils heat the combined foil tab stack.

16. The method of claim 13, further comprising:
cooling at least one of a portion of the clamp or the subclamp configured to hold the electrode stack during hot-pressing the combined foil tab stack.

17. A method for consolidating a foil tab stack, comprising:
combining foil tabs of an electrode stack in a battery cell to form a combined foil tab stack, wherein the foil tabs are formed of copper or aluminum;
clamping the combined foil tab stack to hold the foil tab stack in place, wherein the electrode stack is supported by a clamp, and wherein the combined foil tab stack is supported by a subclamp;
hot-pressing the combined foil tab stack using heated pressing dies to form a consolidated foil tab stack;
cooling at least a portion of the consolidated foil tab stack using a cooling system, where the cooling system is integrated into the subclamp; and
laser welding the consolidated foil tab stack to a terminal lead using a high frequency oscillating laser welder.

18. The method of claim 17, wherein cooling at least the portion of the clamp includes using a Peltier plate.

19. The method of claim 17, wherein hot-pressing the combined foil tab stack includes heating the combined foil tab stack to a temperature between 350 Kelvin and 680 Kelvin and holding the temperature for between 5 seconds and 30 minutes.

20. The method of claim 17, wherein cooling at least the portion of the clamp includes using cooling channels in the subclamp.
